(19) United States
(12) Patent Application Publication
(10) Pub. No.: US 2026/0179981 A1
(43) Pub. Date: Jun. 25, 2026

(54) POWER SUPPLY SYSTEM FOR A PROPULSION SYSTEM OF AN AIRCRAFT

(71) Applicant: MTU Aero Engines AG, Muenchen (DE)

(72) Inventors: Stephan LELLEK, Garching (DE); Barnaby LAW, Starnberg (DE); Thomas SCHERER, Hamburg (DE)

(21) Appl. No.: 19/125,863

(22) PCT Filed: Oct. 23, 2023
(86) PCT No.: PCT/DE2023/100787

§ 371 Date: Apr. 30, 2025

(30) Foreign Application Priority Data
Nov. 3, 2022 (DE) 10 2022 129 030.1

(51) Int. Cl. H01M 8/04223; B64D 27/02; H01M 8/0267; H01M 8/04007; H01M 8/04701; H01M 8/10; H01M 8/248

(52) U.S. Cl. CPC H01M 8/04268; B64D 27/026; H01M 8/0267; H01M 8/04074; H01M 8/04701; H01M 8/248; H01M 2008/1095

(57) ABSTRACT

A power supply system (1) for a propulsion system (40) of an aircraft (50), including a first heat source (11) in the form of a fuel cell unit (21), a second heat source (12), and a heat exchanger (13). The first and second heat sources (11, 12) and the heat exchanger (13) are connected to one another in a cooling circuit (14) for conducting a cooling fluid (16). The first heat source (11) has a first optimal operating temperature T_{opt_1} and the second heat source (12) has a second optimal operating temperature T_{opt_2}. The first optimal operating temperature T_{opt_1} is greater than the second optimal operating temperature T_{opt_2} (T_{opt_1}>T_{opt_2}). A recirculation circuit (19) is associated with the first heat source (11) in the cooling circuit (14), via which cooling fluid (16) already utilized during operation for cooling the first heat source (11) is reusable for cooling the first heat source (11) before passing through the heat exchanger (13). The heat exchanger (13) includes an actuatable inlet (13.1).

### TECHNICAL FIELD

The present invention relates to a power supply system for a propulsion system of an aircraft.

### BACKGROUND

The aircraft may in particular be a propeller airplane, it being possible for the kinetic energy utilized for generation of propulsion to be applied, at least in part, using an electric motor. The present subject matter is directed to a system that is provided for supplying power to the electric motor and that includes a fuel cell unit for the delivery of electrical power. The fuel cell unit may include a fuel cell stack, also referred to as a stack, in which a plurality of fuel cells, each having a plate-like shape, are connected adjacently to one another and thus in series in a stacking direction. During operation, reaction gases such as hydrogen and (atmospheric) oxygen may flow through the fuel cell stack, thus delivering electrical power. This is intended to illustrate one advantageous field of application, but not to limit the generality of the subject matter from the outset.

### SUMMARY OF THE INVENTION

It is an object of the present invention to provide an advantageous power supply system.

The present invention provides a power supply system. In addition to the fuel cell unit (first heat source), the power supply system includes a second heat source, the heat sources being connected to a heat exchanger in a shared cooling circuit. A first optimal operating temperature T_{opt_1} of the first heat source (fuel cell unit) is above a second optimal operating temperature T_{opt_2} of the second heat source, and in addition a recirculation circuit is associated with the first heat source (fuel cell unit). By use of this recirculation circuit, during operation a cooling fluid that has already been utilized in a particular pass for cooling the first heat source (fuel cell unit) is or may be reused, at least in part, for cooling the first heat source before passing through the heat exchanger.

The cooling circuit may thus be operated at a temperature below the temperature (T_{opt_1}) that is actually optimal for operating the fuel cell unit, it being possible to locally set a slightly higher temperature (corresponding to first optimal operating temperature T_{opt_1}) for the fuel cell unit via the recirculation. However, cooling power, which in particular is available on comparatively short notice, is “stockpiled” in the cooling circuit with regard to the fuel cell unit. When a load variation occurs, for example, i.e., when the fuel cell unit must deliver more electrical power and conversely must be more intensely cooled, for example the portion that is recirculated in the system according to the present invention during normal operation may be decreased, and correspondingly the cooling power for the fuel cell unit may be increased. Since this cooling power per se is already in the system or circuit, i.e., for example does not have to first be “generated” by modified operation of the heat exchanger, it can be made available relatively quickly. This may be advantageous in particular with regard to the fuel cells, for example to assist with ensuring operation of same which is safe and/or optimized with respect to the power output.

Preferred embodiments are set forth in the dependent claims and the disclosure as a whole. In the description of the features, a distinction is not always specifically made between device aspects, method aspects, or use aspects; in any case, the disclosure is to be construed implicitly with respect to all claim categories. For example, if the advantages of the power supply system are described for a certain operating mode, at the same time this is to be understood as a disclosure of a corresponding operating method, as well as the description of a certain operating mode on a power supply system configured for this purpose.

The heat sources and the heat exchanger are connected to one another in the cooling circuit; for example, the heat sources are connected to the heat exchanger in series. However, the heat sources may also be situated relative to one another in a parallel connection, for example, and regardless of these details, within the scope of the present disclosure the “interconnectedness” or “connectedness” refers to a corresponding fluidic connection (piping) through which the cooling fluid may flow during operation. Due to the circuit architecture, the cooling system as a whole is designed for repeated flow of the same cooling fluid through the individual components, for which reason according to the main claim, reference is made to the passage through the heat exchanger after the cooling of the first heat source.

Of course, the cooling fluid may flow continuously through the overall system during operation; however, if one considers an individual volume element thereof, this element passes repeatedly through the heat exchanger and the first and/or second heat source (as a function of the recirculated portion also passing multiple times through the first heat source). In general, statements concerning the relative positioning of the individual components in the cooling circuit, i.e., “before” and “after,” refer to the flow direction of the cooling fluid during operation; i.e., a particular unit volume of the cooling fluid will flow through an “upstream” component before flowing through a “downstream” component.

In the cooling circuit there may also be a reservoir, for example, in which cooling fluid may be collected and kept ready for a new pass. In general, within the scope of the present disclosure, unless expressly stated otherwise, “a” and “an” are to be understood as the indefinite article, and thus also as “at least one.” Thus, for example, there may also be more than one heat exchanger and/or more than two heat sources in the cooling circuit.

In detail, a first cooling section of the cooling circuit is associated with the first heat source, it being possible for this first cooling section to also be generally provided, relative to the first heat source, as an external cooling element. Although this external cooling element may be able to functionally discharge the heat from the fuel cell unit, for example due to a thermally conductive unit, it is not further integrated with same. In one preferred embodiment, however, the first cooling section extends through the fuel cell unit, in particular through a channel structure defined by the fuel cells. In particular, a respective fuel cell may include, for example, a so-called bipolar plate that defines a channel structure for the cooling fluid (and typically also for the reaction gas(es)).

Regardless of whether the first cooling section is provided externally or in an integrated manner, the recirculation circuit connects an outlet of the first cooling section to an inlet thereof. This may offer advantages, also in a stationary arrangement, regardless of modification of the recirculated portion, since two different temperatures may thus be achieved in the same cooling circuit. However, a controllable valve via which the recirculated portion may be adjusted is preferably provided in the recirculation circuit. The power supply system may then include a controller, for example, that is configured to appropriately activate the controllable valve depending on the operating state (normal operation, etc.; see the discussion below for a detailed explanation) for modifying the recirculated portion.

According to one preferred specific embodiment, the second heat source includes or is an electronic control unit, preferably a motor control unit of an electric motor of the drive. An electronic control unit that is semiconductor-based may have a lower optimal operating temperature compared to the fuel cell unit, and may thus enable the above-described operating mode with a cooling circuit that is “supercooled” with respect to the fuel cell unit. Alternatively, however, the second heat source may generally also be a voltage converter or an electric motor, for example, such as the propulsion-generating motor itself or an auxiliary motor of the power supply system, or in general the on-board electrical system of the aircraft, for example a compressor motor.

In general, the heat exchanger may be used to withdraw thermal energy from the cooling fluid, the thermal energy being discharged via an external material flow or fluid flow. The ambient air flowing past during operation, i.e., during flight, feeds the external fluid flow, and may be “picked up” at the fuselage of the airplane or also at or in the propulsion unit. The heat exchanger has an actuatable inlet, so that the external fluid flow led into the heat exchanger for heat dissipation may be adjusted, i.e., throttled or increased as necessary. This may take place using a flap, a diaphragm, or an adjustable inlet grille, for example. Regardless of these details, the actuatable inlet may allow advantageous operation in such a way that the inlet is opened during a landing operation, which results in increased cooling power and at the same time, greater air resistance.

In other words, at least a portion of the kinetic energy is converted into cooling power, and by increasing the portion that is led through the recirculation circuit, the temperature of the fuel cell unit may at the same time be held in an adequate range; i.e., in any case a temperature drop that is identical to the cooling circuit may be avoided. For a semiconductor-based control unit, although the optimal operating temperature (T_{opt_2}) may be set to be higher than that temporarily present in the cooling circuit, the control unit may still be reliably operated, even at lower temperatures. As a result, via the described cooling during the landing operation, coldness may be kept ready in the cooling circuit, which generally may be advantageous with regard to a subsequent start-up operation, but in particular with regard to a possible restart maneuver. Namely, at that time there is temporarily no longer a demand for electrical power from the fuel cell unit, so that it may conversely be cooled more intensely (more intensely than during normal operation, i.e., under cruise conditions, for example).

As mentioned above, in one preferred embodiment a reservoir for the cooling fluid, in which the cooling fluid may be collected and then recirculated, is also provided in the cooling circuit. The reservoir in the cooling circuit is preferably situated downstream from the first and/or second heat source and upstream from the heat exchanger.

According to one preferred specific embodiment, the first and the second optimal operating temperature differ by at least 5 K. In absolute values, the first optimal operating temperature may be, for example, approximately 70° C. and the second optimal operating temperature may be approximately 60°, for example with a fluctuation range of +/−3° C., preferably +/−2° C., in each case. Also regardless of these details, possible upper limits of the difference between the optimal operating temperatures may be at most 20 K, 15 K, or 10 K, for example.

According to one preferred specific embodiment, the power supply system includes a controller or control unit which in the form of a microcontroller, for example, may be integrated as a separate controller or also functionally into a higher-order computer system of the aircraft. Regardless of the particular implementation, commands for bringing about a certain operation of the power supply system are stored in the control unit. Via an appropriate command structure, the controller may be configured in particular to operate the first heat source at a first temperature T₁, and the second heat source at a second temperature T₂ that is lower than the first temperature.

The first temperature preferably corresponds essentially to the first optimal operating temperature, and the second temperature preferably corresponds essentially to the second optimal operating temperature. By use of the controller, the first temperature may be set, for example by adjusting the recirculated portion, and/or the second temperature may be set, for example by activating the heat exchanger. For this purpose, for example temperatures that are detected at one or multiple locations in the cooling circuit may also be entered into the controller; i.e., the controller may be connected to one or multiple temperature sensors.

Moreover, the present invention relates to an aircraft that includes a power supply system that is disclosed above, in particular an airplane, for example a propeller airplane. However, its propulsion system, which may include, for example, at least one propulsion unit with an electric motor and a propeller, generally is even a multimotor system, for example of the Do228 type, and is supplied with electrical power by the fuel cell unit of the power supply system.

Furthermore, the present invention relates to a method for operating a power supply system or aircraft disclosed above, the first heat source being operated at a first temperature and the second heat source being operated at a second temperature. As explained above with regard to the controller, the first and second temperatures correspond essentially to the respective optimal operating temperature (for example, with a maximum deviation of +/−3 K or +/−2 K). Conversely, however, the exact optimal operating temperatures do not have to be reached, and merely an approximation may allow adequate operation.

In one preferred embodiment, at least temporarily, i.e., at least in one operating state, a cooling fluid that has already been utilized for cooling the fuel cell unit is led once again through the recirculation circuit to the first cooling section, i.e., is used for cooling the fuel cell unit, before it reaches the heat exchanger. Thus, as explained in detail above, a temperature is set for the fuel cell unit that is higher compared to the cooling circuit. The recirculated portion is preferably modified over the course of time; i.e., it is greater in a first operating state than in a second operating state. The first operating state may in particular correspond to normal operation, for example when traveling at flight altitude (cruise conditions). In contrast, the second operating state may correspond to a start-up or restart maneuver in which greater electrical power and consequently more intense cooling are temporarily necessary.

The heat exchanger includes an actuatable inlet (see above) that is opened during a landing operation. Cooling power may thus be “stockpiled” in the cooling circuit (see the comments above in this regard).

Moreover, the present invention relates to the use of a propulsion system of an aircraft (see above for possible details) together with a power supply system described above.

### BRIEF DESCRIPTION OF THE DRAWINGS

The present invention is explained in greater detail below based on one exemplary embodiment, it being possible for the individual features, within the scope of other claims, to also be in some other combination that is essential to the present invention, in particular a distinction also not being made between the different claim categories.

In the figures:

FIG. 1 shows a power supply system according to the present invention in a schematic illustration;

FIG. 2 shows a propulsion system of an aircraft together with a power supply system according to FIG. 1; and

FIG. 3 shows a schematic illustration of an airplane with a propulsion system according to FIG. 2.

### DETAILED DESCRIPTION OF THE INVENTION

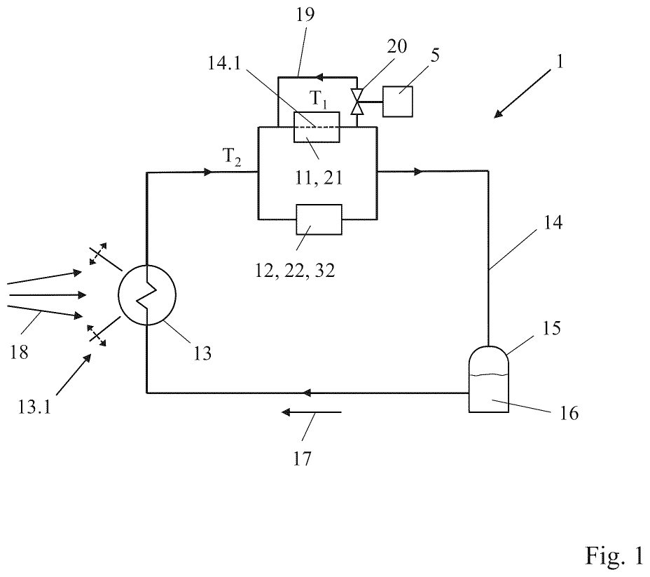

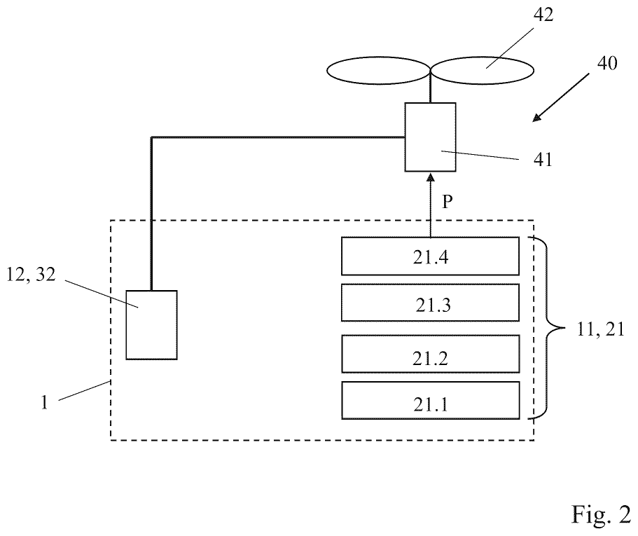

FIG. 1 shows a power supply system 1 that includes a first heat source 11 and a second heat source 12 as well as a heat exchanger 13, which are connected to one another in a cooling circuit 14. In detail, first heat source 11 is a fuel cell unit 21 and second heat source 12 is a control unit 22, in particular a motor control unit 32 (see FIG. 2 for details). Also provided in cooling circuit 14 is a reservoir 15 in which during operation a cooling fluid 16 may be collected before recirculation through the cooling circuit 14. A flow direction 17 of cooling circuit 14 is denoted by arrows.

Cooling fluid 16 is cooled in heat exchanger 13; i.e., heat is discharged via an external fluid flow 18. An inlet 13.1 of heat exchanger 13 is actuatable; i.e., throughflow with the external fluid flow 18 may be adjusted. Downstream from heat exchanger 13, first and second heat sources 11, 12 are cooled with cooling fluid 16. First heat source 11 has a first optimal operating temperature T_{opt_1}, and second heat source 12 has a second optimal operating temperature T_{opt_2} that is lower than the first optimal operating temperature. A recirculation circuit 19, through which a cooling fluid that has already been utilized for cooling first heat source 11 is led in part through first cooling section 14.1, i.e., may be reused for cooling first heat source 11, is associated with heat source 11.

In this way, a second temperature T₂ may be set in cooling circuit 14 which, for example, essentially corresponds to the second optimal operating temperature and is lower than the first optimal operating temperature. Due to the partial recirculation, for first heat source 11, at the same time a first temperature T₁ may be set which is higher than second temperature T₂ and which, for example, essentially corresponds to the first optimal operating temperature. The recirculated portion is preferably modifiable, for which purpose a controllable valve 20 that is activated via a controller 5 may be provided in recirculation circuit 19. With regard to further operating details, in particular concerning actuatable inlet 13.1 of heat exchanger 13, reference is made to the introduction to the description.

FIG. 2 shows power supply system 1 once again in a schematic manner, but with an illustration of its connection to a propulsion system 40. The propulsion system includes an electric motor 41 that drives a propeller 42, electrical power P being provided by fuel cell unit 21 for this purpose. The fuel cell unit is in particular made up of multiple stacks 21.1 through 21.4, which in turn each contain a plurality of fuel cells. Together with motor control unit 32 via which electric motor 41 is activated, fuel cell unit 21 forms the two heat sources 11, 12, which are linked to one another in power supply system 1 in the manner explained with reference to FIG. 1.

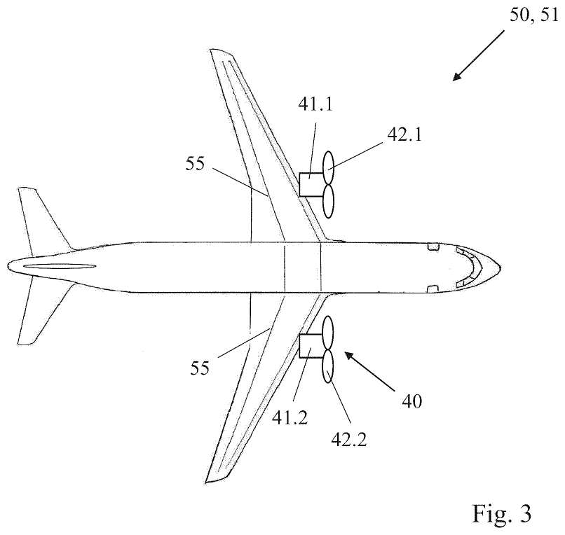

FIG. 3 shows a schematic top view of an aircraft 50, in particular an airplane 51. In this case, propulsion system 40 includes two motors 41.1, 41.2 with a respective propeller 42.1, 42.2, which in this example are situated at wings 55 of airplane 51.

### LIST OF REFERENCE NUMERALS

1 power supply system
5 controller
11 first heat source
12 second heat source
13 heat exchanger
13.1 inlet
14 cooling circuit
14.1 first cooling section
15 reservoir
16 cooling fluid
17 flow direction
18 fluid flow
19 recirculation circuit
21 fuel cell unit
21.1 through 21.4 stacks
22 control unit
32 motor control unit
40 propulsion system
41 electric motor
41.1, 41.2 motors
42 propeller
42.1, 42.2 propellers
32 motor control unit
50 aircraft
51 airplane
55 wing

What is claimed is:

1-13. (canceled)

14: A power supply system for a propulsion system of an aircraft, the power supply system comprising:
a first heat source in the form of a fuel cell unit;
a second heat source;
a heat exchanger including an actuable inlet;
a cooling circuit for conducting a cooling fluid and connecting the first and second heat sources and the heat exchanger, the first heat source having a first optimal operating temperature T_{opt_1} and the second heat source having a second optimal operating temperature T_{opt_2}, the first optimal operating temperature T_{opt_1} being greater than the second optimal operating temperature T_{opt_2} (T_{opt_1}>T_{opt_2}); and
a recirculation circuit associated with the first heat source in the cooling circuit, cooling fluid already utilized during operation for cooling the first heat source being reusable via the recirculation circuit for cooling the first heat source before passing through the heat exchanger.

15: The power supply system as recited in claim 14 wherein the cooling circuit includes a first cooling section associated with the first heat source, the first cooling section passing through the fuel cell unit.

16: The power supply system as recited in claim 14 wherein the second heat source includes an electronic control unit.

17: The power supply system as recited in claim 16 wherein the electronic control unit is a motor control unit of an electric motor connected to the fuel cell unit for supplying electrical power.

18: The power supply system as recited in claim 14 wherein the cooling circuit includes a reservoir for the cooling fluid.

19: The power supply system as recited in claim 14 wherein the first optimal operating temperature T_{opt_1} is greater than the second optimal operating temperature T_{opt_2} by at least 5 K.

20: The power supply system as recited in claim 14 further comprising a controller configured to operate the first heat source at a first temperature T₁, and the second heat source at a second temperature T₂, with T₁ being greater than T₂ (T₁>T₂).

21: An aircraft comprising the power supply system as recited in claim 14.

22: An airplane comprising the power supply system as recited in claim 14.

23: A method for operating the aircraft as recited in claim 21, the method comprising:
operating the first heat source at a first temperature T₁ and the second heat source at a second temperature T₂, with T₁ being greater than T₂ (T₁>T₂); and
opening the actuatable inlet during a landing operation in order to accumulate cooling power in the power supply system before a new start-up or restart operation.

24: The method as recited in claim 23 wherein the cooling fluid already been utilized for cooling the first heat source is led, at least temporarily and at least in part, through the recirculation circuit and reused for cooling the first heat source before passing through the heat exchanger.

25: The method as recited in claim 24 wherein a portion of the cooling fluid recirculated through the recirculation circuit is greater in a first operating state than in a second operating state.

26: The method as recited in claim 25 wherein the first operating state corresponds to normal operation.

27: A method of employing of a propulsion system of an aircraft, the method comprising utilizing the power supply system as recited in claim 14.
